(19) United States
(12) Patent Application Publication
(10) Pub. No.: US 2026/0224030 A1
(43) Pub. Date: Aug. 6, 2026

(54) Cantilever Arm for Receiving and Measuring a Variable Load Weight

(71) Applicant: Digi Sens Holding AG, Freiburg (CH)

(72) Inventors: Damian Schapfel, Rizenbach (CH); Philipp Zaugg, Meyriez (CH)

(73) Assignee: Digi Sens Holding AG, Freiburg (CH)

(21) Appl. No.: 19/157,235

(22) PCT Filed: Jan. 18, 2024
(86) PCT No.: PCT/CH2024/050003

§ 371 Date: Aug. 15, 2025

(30) Foreign Application Priority Data
Feb. 18, 2023 (CH) CH000162/2023
Feb. 21, 2023 (CH) CH000187/2023

(51) Int. Cl. A47B 96/06; G01B 17/04

(52) U.S. Cl. CPC A47B 96/061; G01B 17/04; A47B 2220/0036

(57) ABSTRACT

A cantilever arm (1, 20, 25, 40, 50, 60, 70), which can be anchored on one side to an object, has a flat body (11), which comprises a resilient material and is designed to receive a variable load weight (4) and is positioned in operation with a vertically aligned surface, in such a way that in the operating position it has a height (v) limited by an upper (6) and a lower edge region (7) and a horizontal extension (h), which is limited on the one hand by an anchoring side region (2) for anchoring the cantilever arm (1, 20, 25, 40, 50, 60, 70) to the object and on the other hand by a cantilevered side region (8) opposite thereto, wherein the cantilever arm (1, 20, 25, 40, 50, 60, 70) further comprises a force application arrangement designed for supporting the load weight (4), characterized in that the flat body (11) of the cantilever arm (1, 20, 25, 40, 50, 60, 70) forms a deformation opening (10) and a connecting arrangement for a deformation sensor for measuring the deformation of the cantilever arm under a current load weight (4), wherein the deformation opening (10) is formed by the flat body (11), penetrates the flat body and is completely enclosed by the same, wherein all the edge regions of the deformation opening lie in the plane of the flat body (11) and said deformation opening has a horizontal extension (h), limited by the anchoring side region (2) and the cantilevered side region (8), and a vertical extension (v) limited by the upper and lower edge regions, in such a way that it deforms under a respective, current load weight (4) accordingly in a predetermined manner, wherein the force application assembly is formed by the body (11) of the cantilever arm (1, 20, 25, 40, 50, 60, 70), and is designed such that in the operating position of the cantilever arm (1, 20, 25, 40, 50, 60, 70) at least a portion of the load weight (4) is introduced into the cantilevered side region (8), and wherein the connecting arrangement is designed to clamp a deformation sensor between the anchoring side region (2) and the cantilevered side region (8) such that said sensor is operational. The cantilever arm (1, 20, 25, 40, 50, 60, 70) is simple in design, inexpensive to manufacture and allows high-precision measurement of a variable load weight (4) using a deformation sensor (35).

The present invention relates to a cantilever arm according to the preamble of claim 1 and to a frame provided with such cantilever arms according to the preamble of claim 18.

From WO 02/025 230 it is known to manage a warehouse of goods by keeping the goods on a storage area or storing them temporarily, the number of goods being determined by their weight. Likewise, product mutations can be detected via the resulting weight change and processed automatically in warehouse accounting. The weight of the goods is determined by scales or load cells on which the storage area rests.

For storage, for example, it is advantageous to use a frame the vertical supports of which are arranged at a distance and carry shelves between them. The scales are then arranged on the supports and form the support for the shelves, for example, a shelf is supported on each side by a scale. A product mutation is then indicated by a weight change recorded by the scales, wherein the sum of the weight changes of both scales indicates the weight of the mutated scales and the ratio of the weight changes indicates the location of the mutated scale on the shelf.

EP 3 845 873 discloses a cantilever arm suitable for such a frame, which can be easily hooked into the vertical supports of the frame and, in a manner known per se, forms a support for a shelf carrying the goods. The shelf does not rest on the cantilever arm according to its length (and depth), as is usual with such frames, but only at its corner points, and even at the corner points it does not rest on the body of the cantilever arm itself, but on special force application sections of the cantilever arm, which are arranged in a resilient manner so that they can be moved relatively to the body of the cantilever arm. This resilient relative displacement causes a deformation of a joint section between the force application sections and the body of the cantilever arm, wherein horizontally folded weighing sections of the joint section are provided with strain gauges the deformation signals of which are used to calculate the face of the shelf. Weight changes can then be evaluated in the manner described in WO 02/025 230 to determine the location of a mutated product.

EP 3 845 874 further shows a further development of a cantilever arm of the type disclosed in EP '873, wherein a cantilever arm with “integrated weighing functionality” is to be created, and furthermore “the load cell is to take into account specifically the ability to be integrated into a shelf console or into a cantilever arm”.

For this purpose, “monolithic measuring bodies” are provided, which in turn are designed as additional cantilever arms and each have a force application section, joint section and anchoring section. The cantilever arm anchored to the frame is then provided with the other cantilevers in such a way that their anchoring sections are fixed to the body of the cantilever arm anchored to the frame and their force application sections can support the shelf. As a result, the joint sections of the other cantilever arms deform according to the weight exerted on them by the shelf. This deformation is detected by four strain gauges arranged in the joint sections, with evaluation electronics using a Wheatstone bridge generating the desired weight signal.

A disadvantage of the disclosed arrangement with nested cantilever arms is the comparatively complicated structure, which is complex and expensive and, for example, when used in a frame as a holder for a shelf, has large lateral dimensions.

Accordingly, it is the object of the present invention to provide a structurally simplified, inexpensively manufactured cantilever arm which can also be used for the reliable detection of comparatively small weight changes.

This object is achieved by a cantilever arm having the features of claim 1 or a frame having the features of claim 17.

Since the cantilever arm according to the invention, including the force application arrangement, the deformation opening, the connecting arrangement for connection to a deformation sensor (often also referred to simply as a “force sensor”) and also the force application arrangement, is designed to be flat, it can be manufactured, for example, from a sheet metal in the simplest and most cost-effective way, e.g., punched and used without further forming. It has the smallest possible lateral volume, which is useful when the cantilever arm is used to build a storage frame, for example, and thus provides maximum storage space. Since the deformation opening is provided in the flat body itself and has a horizontal extension, a relative displacement of its side edges, which are spaced apart from one another in the horizontal direction and lie in the plane of the flat body of the cantilever arm, results under the variable load weight, which in turn is a measure of a current load weight and has a value that lies within the operating range of a conventional deformation sensor and can therefore be detected perfectly by it. The deformation signal of the deformation sensor can then be easily recorded and evaluated by evaluation electronics that are generally known to those skilled in the art. In addition to the stated task, the deformation opening allows for the simple provision of a vibrating wire sensor, which as such is particularly suitable for long-term drift-free and highly precise measurement of the smallest differences in current load weight, without increasing the manufacturing effort for the cantilever arm or its dimensions.

Further preferred embodiments have the features of the dependent claims.

The invention is described in more detail below with reference to the figures.

In particular:

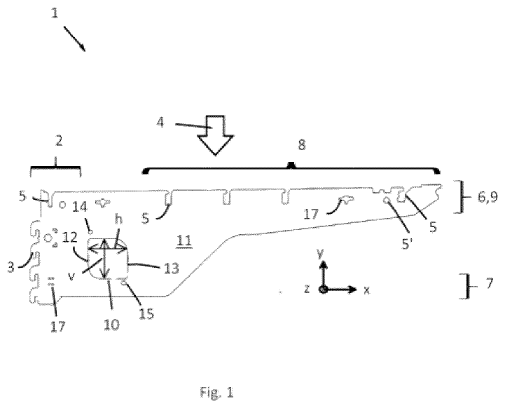

FIG. 1 shows a side view of a cantilever arm according to the invention in a basic configuration,

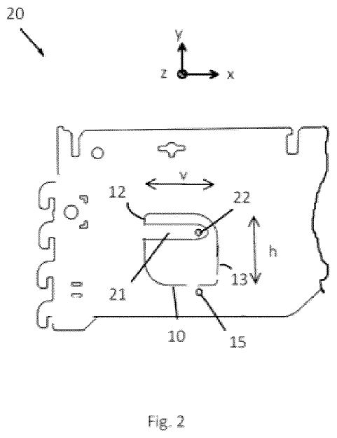

FIG. 2 shows an embodiment of a cantilever arm according to the invention with a modified connecting arrangement,

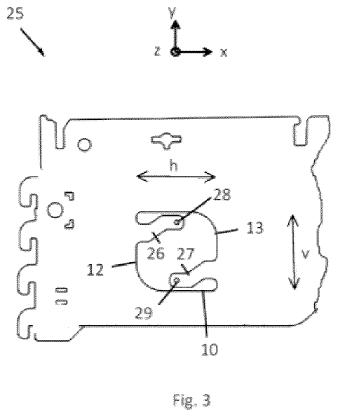

FIG. 3 shows an embodiment of a cantilever arm according to the invention with a further modified connecting arrangement,

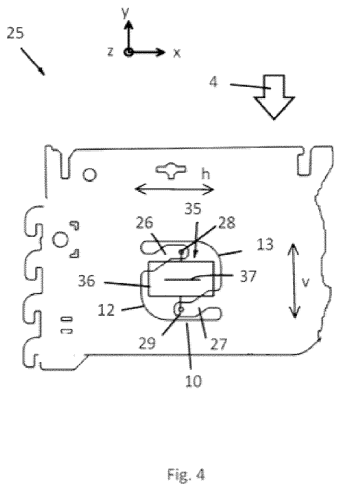

FIG. 4 shows an embodiment of a cantilever arm according to the invention, which is equipped with a deformation sensor,

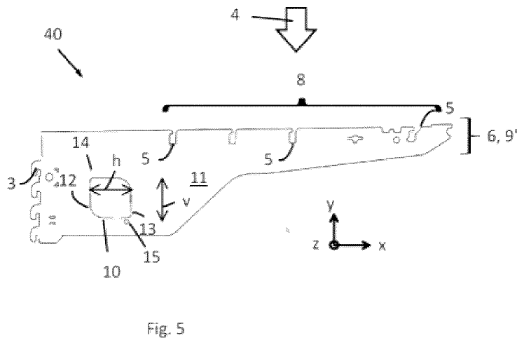

FIG. 5 shows an embodiment of a cantilever arm according to the invention, the force application arrangement of which is modified,

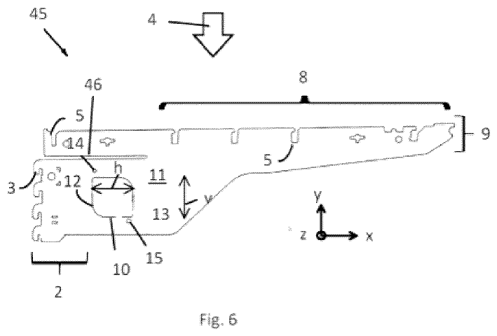

FIG. 6 shows an embodiment of a cantilever arm according to the invention, with a further, modified force application arrangement,

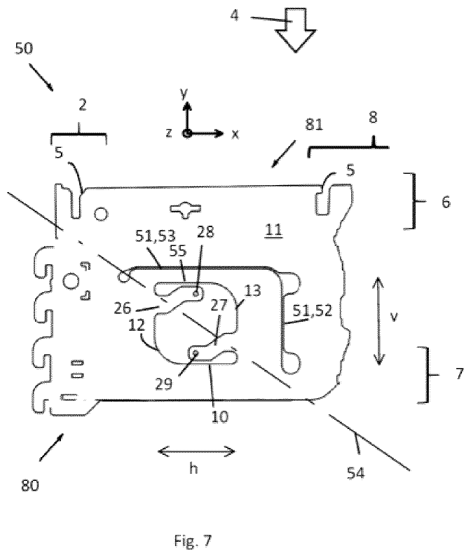

FIG. 7 shows an embodiment of a cantilever arm according to the invention, with a rectification opening,

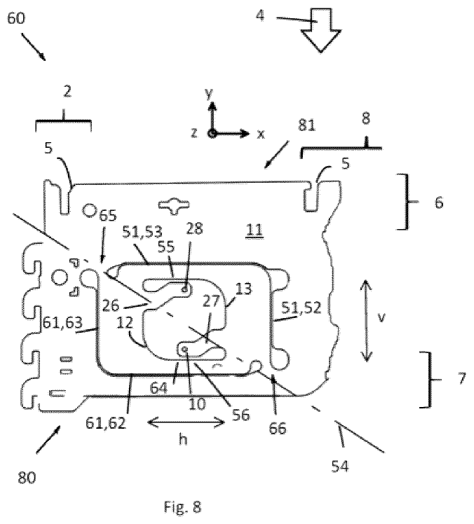

FIG. 8 shows an embodiment of a cantilever arm according to the invention, with two rectification openings,

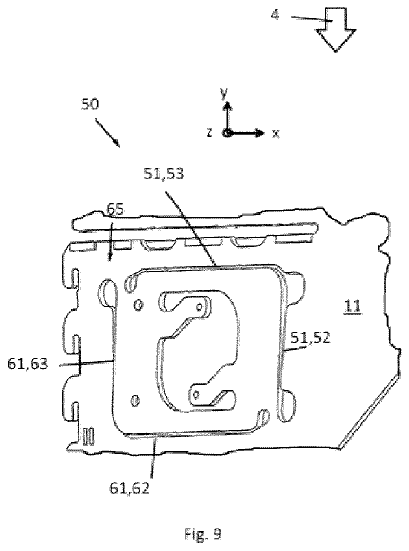

FIG. 9 shows the deformation of the cantilever arm according to the invention according to a simulation,

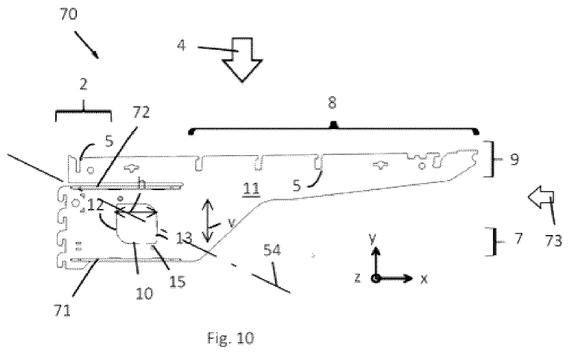

FIG. 10 shows an embodiment of a cantilever arm according to the invention, with stiffening ribs,

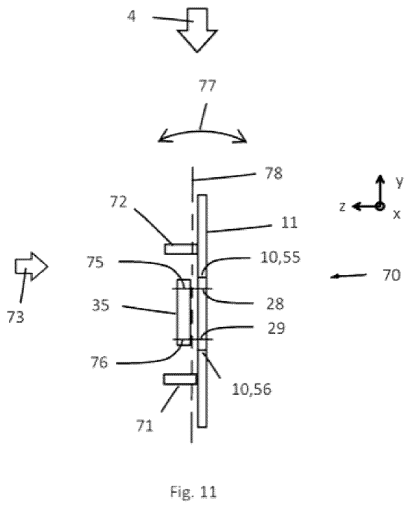

FIG. 11 shows the embodiment with stiffening ribs in a front view, and

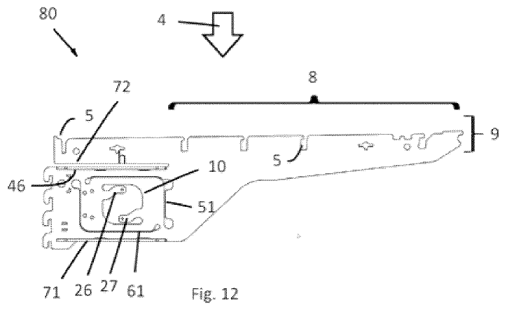

FIG. 12 shows a further embodiment of a cantilever arm according to the invention.

FIG. 1 shows a side view of an embodiment of a cantilever arm 1 according to the invention in a basic configuration, which has been punched out, for example, from a 1 to 3 or even 4 mm thick sheet metal and thus has a flat body 11 made of a resilient material, the outline of which is shown in the figure. The person skilled in the art can also choose a different thickness of the sheet metal that is appropriate for the intended maximum load weight. The cantilever arm 1 shown can be used, among other things, in known and widely used storage frames with vertical supports and has, for this purpose, an anchoring side region 2 provided with hooks 3 which can be inserted into corresponding slots on the support, as is generally known. However, the anchoring side region 2 can be modified by the person skilled in the art in the specific case in order to be arranged in an operative manner, i.e. in a vertical position, on any other object (other than a vertical support).

The cantilever arm 1 shown is thus designed to be anchored to an object such as a vertical support with one side and to cantilever freely to the other side.

In the operating position, i.e. in the anchored position, the cantilever arm 1 is positioned with its surface oriented vertically so that the plane of FIG. 1 is oriented vertically. The cantilever arm 1 can then support a load weight 4 directed vertically downwards, such as occurs when a shelf resting on the cantilever arm 1 in a known manner is loaded with goods. The load weight is variable, depending on which and how many goods are loaded on the shelf. It is known to the person skilled in the art how to fix a suitably designed shelf in recesses 5 in a reliable manner.

The coordinate system shown in FIG. 1 thus denotes with y a height, with x a horizontal extent and with z a thickness of the cantilever arm 1, where z projects vertically from the plane of the drawing. The height of the cantilever arm 1 is thus limited by an upper edge region 6 and a lower edge region 7. The horizontal extension of the cantilever arm 1 is limited by the anchoring side region 2 and the cantilevered side region 8.

The upper edge region 6 together with the recesses 5 forms a force application arrangement 9, via which the load weight 4 is applied to the cantilever arm 1. The recesses 5 serve in a known manner, for example, to place a shelf omitted to simplify the figure onto the cantilever arm 1. The force application arrangement 9 is thus arranged at least partially on the cantilevered side region 8 and, during operation, introduces at least part of the operating load 4 into the side region 8.

A deformation opening 10 penetrates the flat body 11 of the cantilever arm 1 and is located therein in such a way that it is completely enclosed by it. It has a horizontal extension h, limited on one side by the anchoring side region 2 and on the other side by the cantilevered side region 8. Furthermore, it has a vertical extension v, which is limited by the upper 6 and lower edge region 7. Finally, all edge regions of the deformation opening 10 lie in the plane of the flat body 11, i.e. they are not formed out of this plane in any way.

If the load weight 4 acts on the cantilever arm 1, in the embodiment shown in the figure over the entire horizontal extent of the cantilever arm 1 (the force application arrangement 9 extends over its entire horizontal extent in the embodiment shown), at least a part of the load weight 4 is introduced into the cantilevered side region 8. Since it is freely cantilevered, it moves downwards according to the resilient properties of the body 11, while the fixed anchoring side region 2 remains stationary. The deformation opening also deforms accordingly, the edge region 12 of which facing the anchoring side region is essentially unaffected by the displacement, while its edge region 13 facing the cantilevered side region follows the displacement. The opposing edge regions 12, 13 are thus subject to a relative displacement, depending on the value of the currently acting load weight 4.

During operation, i.e. when the operating load 4 acts on the cantilever arm 1, there is no relative displacement between the part of the force application arrangement 9 arranged on the cantilevered side region 8 and the cantilevered side region 8, since the openings 5 and 5′ are rigidly arranged thereon. The operating load 4 acts on the deformation opening 10 via the cantilevered side region 8 and thus causes the relative displacement of the edge regions 12, 13 of the deformation opening 10 described above.

The cantilever arm 1 further comprises a connecting arrangement formed in the embodiment shown by bores 14, 15, in which a suitable deformation sensor 16 (see, for example, FIG. 4), which is omitted to simplify the figure, can be anchored to the body 11. The relative displacement of the edge regions 12, 13 results in a relative displacement of the bores 14, 15, which is detected by the deformation sensor 16, wherein the deformation sensor 16 then generates a deformation or load signal, which in turn can be output as a weight by a suitable evaluation electronics, which is generally known to the person skilled in the art, and can be used, for example, in warehouse accounting. To reduce the complexity of the figure, the evaluation electronics including the associated cables etc. have been omitted.

It should be noted that the person skilled in the art can adjust the dimensions of the deformation opening with the aid of a simulation calculation or by tests in such a way that the relative displacement of the edge regions 12, 13 in the intended range of the possible load weight 4 lies in a suitable manner within the operating range of the deformation sensor 16. The connecting arrangement is thus preferably designed to operatively clamp a deformation sensor between the anchoring side region and the cantilevered side region. As explained below, the deformation sensor 16 is preferably designed as a vibrating wire sensor, but can also consist of an expandable body equipped with strain gauges. Finally, it should be noted that the cantilever arm 1 further has the openings 17 shown in the figure, which serve to anchor covers, fix cables, etc. and are irrelevant for the function of the cantilever arm 1 or the deformation opening 10 for measuring the operating load 4.

The cantilever arm shown in FIG. 1 is of very simple design, can be manufactured in a single punching process and, apart from the installation of a deformation sensor, can basically be used without further production steps. Compared to prior art cantilever arms that incorporate a load cell or weight sensor, it is extremely cost-effective. At the same time, despite the thin body 11, it can accommodate high load weights due to its vertical operating position (very high moment of inertia in the load direction).

It should be noted that the force application arrangement does not necessarily have to be designed to accommodate a shelf resting on the cantilever arm 1. Instead of the recesses 5, for example, an opening 5′ can be provided into which an operating load 4′ is suspended. In the specific case, the person skilled in the art can suitably design the force application arrangement so that the use of the cantilever arm according to the invention is not exclusively tied to the shelves of a conventional frame.

A cantilever arm is obtained, which can be anchored on one side to an object, has a flat body, which comprises a resilient material and is designed to receive a variable load weight and is positioned in operation with a vertically aligned surface, in such a way that in the operating position it has a height limited by an upper and a lower edge region and a horizontal extension, which is limited on the one hand by an anchoring side region for anchoring the cantilever arm to the object and on the other hand by a cantilevered side region opposite thereto, wherein the cantilever arm further comprises a force application arrangement designed for supporting the load weight, in which the flat body of the cantilever arm further forms a deformation opening and a connecting arrangement for a deformation sensor for measuring the deformation of the cantilever arm under a current load weight, wherein the deformation opening is formed by the flat body, penetrates the flat body and is completely enclosed by the same, wherein all its edge regions lie in the plane of the flat body and said deformation opening has a horizontal extension, limited by the anchoring side region and the cantilevered side region, and a vertical extension limited by the upper and lower edge regions, in such a way that it deforms under a respective, current load weight accordingly in a predetermined manner, wherein furthermore the force application arrangement is formed by the body of the cantilever arm, and is designed such that in the operating position of the cantilever arm at least a portion of the load weight is introduced into it without any relative displacement between it and the cantilevered side region, and wherein the connecting arrangement is designed to clamp a deformation sensor between the anchoring side region and the cantilevered side region such that said sensor is operational.

FIG. 2 shows a section of a cantilever arm 20, which is basically designed like the cantilever arm 1 (FIG. 1), wherein its deformation opening 10 has a modified connecting arrangement for the connection to a deformation sensor. The modified connecting arrangement here additionally has an arm 21 which projects from the edge region 12 into the deformation opening 10 and has a bore 22 which, like the bore 15, is provided for fixing the deformation sensor. The arm allows the bores 15, 22 to be arranged essentially one below the other, so that the deformation sensor clamped through these bores 15, 22 is no longer inclined to the vertical (as in the embodiment according to FIG. 1) but is aligned vertically and the relative displacement of the bores 15, 22 is less subject to a deformation or distortion of the deformation opening 10 caused not by the load weight 4, but by the shape of the body 11 of the cantilever arm 20. This eliminates even minor measurement errors, namely improves the measurement accuracy achievable by the cantilever arm according to the invention.

Analogously, it can also be provided that an arm extends from the edge 13 of the deformation opening 10 into it. This results in a cantilever arm in which the connecting arrangement preferably has at least one arm which projects into the deformation opening from one of its side regions and has a connecting device for the deformation sensor at a head region.

FIG. 3 shows a section of a cantilever arm 25 with a further modified connecting arrangement for the connection to a deformation sensor. Two arms 26 and 27 with bores 28 and 29 for clamping a deformation sensor are visible. The arms 26 and 27 each protrude from one of the sides 12, 13 of the deformation opening 10 into its interior, with the advantage that the bores are (vertically) one below the other and there is ideal space for the deformation sensor inside the deformation opening 10.

This preferably results in a cantilever arm in which the connecting arrangement has two arms, one arm protruding from the anchoring side region and the other arm protruding from the cantilevered side region into the deformation opening 10, and each arm has a head region with a connecting device (bores 28, 29) for the deformation sensor.

Further preferably, the two arms are designed such that their connecting devices (bores 28, 29) for the deformation sensor are arranged substantially vertically one above the other at a distance in the operating position of the cantilever arm 25. Thus, the distance between the bores 28, 29 is less affected by the distortion of the deformation opening 10 which is not in the load direction of the operating load 4, compared to an obliquely positioned deformation sensor (see also above).

Further preferably, the head region of the arm from the anchoring side region is closer to the upper side region and the head region of the arm from the cantilevered side region is closer to the lower side region of the cantilever arm. Thus, the distance between the bores 28, 29 is optimally affected to a small extent by the distortion of the deformation opening 10 which is not in the load direction of the operating load 4. For such a distortion s, see, for example, the description of FIG. 7 or 8.

FIG. 4 shows a section of, for example, a cantilever arm 25 according to FIG. 3, wherein a schematically illustrated deformation sensor designed as a vibrating wire sensor 35 is operatively clamped into the connecting arrangement. Vibrating wire sensors of the type shown schematically are known to those skilled in the art and are available, for example, under the designation KL66 from Digi Sens AG. It is preferred that a cantilever arm according to the invention further comprises a deformation sensor operatively clamped in the connecting arrangement.

The vibrating wire sensor 35 has an elastically deformable elastic body, designed here as a frame 36, which is connected at both its ends to the bores 28 and 29 and is thus subjected to tension when a load weight 4 is applied. As a result, the elastic body deforms in such a way that a deformation measuring element designed as a vibrating string 37 is placed under increased (or reduced) tension compared to a rest state, thus having a changed resonance frequency and thus detecting the deformation of the elastic body (here the frame 36) and thus simultaneously the relative displacement of the bores 28, 29. The deformation signal of the vibrating wire sensor 35 can be converted by an evaluation electronics in a manner known to the person skilled in the art into a signal for the magnitude of the currently acting operating load 4. It is preferred that the deformation sensor comprises an elastically deformable body which is clamped in the connecting arrangement in such a way that it is elastically deformed by a deformation of the deformation opening, and wherein a deformation measuring element is arranged on the elastic body which detects a deformation of the elastic body. Further preferably, the deformation measuring element is designed as a vibrating wire and the deformation sensor is designed as a vibrating wire sensor.

FIG. 5 shows a further embodiment of a cantilever arm 40 according to the invention, the force application arrangement 9′ of which is designed such that in the operating position of the cantilever arm 40, essentially the entire operating load is introduced into the cantilevered side region 8. For this purpose, the upper edge region 6 is provided with recesses 5 only in the region of the cantilevered side region 8 (see the description of FIG. 1) so that the weight of, for example, a shelf can only rest on the cantilevered side region 8. In this case, such a shelf can be designed to be shortened with an extension in the x direction, so that it only covers the cantilevered side region 8 or can be designed to extend up to the hooks 3, but outside the cantilevered side region 8 not to be supported on the cantilever arm 40. It generally follows that the force application arrangement is preferably provided at the upper edge region 6 and extends at least over the cantilevered side region. Even with this arrangement, a relative displacement between the force application arrangement 9 and the cantilevered side region 8 under an acting operating load is avoided, since the openings 5 and 5′ are rigidly arranged thereon. The operating load 4 thus acts on the deformation opening 10 via the cantilevered side region 8.

FIG. 6 shows a further embodiment of a cantilever arm 45 according to the invention, which, as in the embodiment of FIG. 5, is designed such that in the operating position of the cantilever arm 40, essentially the entire operating load is applied to the cantilevered side region 8. However, in contrast to the arrangement in FIG. 5, the force application arrangement 9 extends over the entire upper edge region 6, as is also the case in the embodiment shown in FIG. 1). However, the cantilever arm 45 additionally has a preferably slot-shaped relief opening 46 which starts from the anchoring side region 2 and extends towards the cantilevered side region 8, which extends over the deformation opening 10 and is located below the force application arrangement 9 and preferably runs over the entire horizontal extent h of the deformation opening 10. The operating load 4 can thus be introduced by the force application arrangement 9 only into the cantilevered side region 8 (and only from there into the deformation opening 10), which in turn prevents the deformation opening 10 from being undesirably distorted, but rather only its edge 13 facing the cantilevered side region 8 is displaced downwards in an almost translational manner without tilting obliquely, wherein, for example, an arm 27 (when using an embodiment according to FIG. 3) is also displaced in an almost translational manner, i.e. essentially does not assume any other angular position by which the distance between the bores 28, 29 (FIG. 3) would be changed by a deformation of the body 11 that is not representative of the value of the load 4. It should be noted that, as before, during operation, the load weight 4 is introduced into the cantilevered side section (8) without any relative displacement between the part of the force application arrangement (9) arranged on the cantilevered side section (8) and the cantilevered side region.

In other words, the relief opening 46 makes it possible to maintain the measuring accuracy even if the force application arrangement 9 extends over the deformation opening 10 or beyond it to the anchoring side region 2 (where, of course, the force application arrangement 9 is then free of hooks 3 there, as shown in FIG. 6). Preferably, the force application arrangement 9 thus extends from the cantilevered side region 8 further over the deformation opening 10 and particularly preferably beyond this to over the anchoring side region 2. Further preferably, starting from the anchoring side region 2, a particularly preferably slot-shaped relief opening 46 is provided which extends towards the cantilevered side region 8 and is located above the deformation opening 10 and particularly preferably runs over its entire horizontal extent h.

FIG. 7 shows a further embodiment of a cantilever arm 50 according to the invention with a rectification opening 51, which is preferably slot-shaped. It runs continuously around a part of the deformation opening 10, namely with a height section 52 at least over a part of its height v and with a horizontal section 53 at least over a part of its horizontal extent h and thus has an L-shaped structure. In the embodiment shown in the figure, the sections 52, 53 run over the entire horizontal x and vertical y extent of the deformation opening 10.

If an operating load 4 acts on the cantilever arm designed according to one of the figures, as mentioned above in the description of FIG. 1, the cantilever arm is stiff in the direction of the operating load 4 and deforms only to the extent that the associated deformation of the deformation opening 10 can be detected by a deformation sensor. In the horizontal z-direction, the cantilever arm is thin and flat and thus flexible, which leads to an undesirable twisting or deformation of the body 11 of the cantilever arm about, for example, an axis 54 (shown in dash-dotted lines) under the acting operating load 4 such that a region 80 of the body 11 located below the axis 54, which comprises at least part of the anchoring side region 12, largely remains in the vertical desired position, but a region 81 located above the axis 54 with the force application arrangement in the z-direction twists or bends or kinked somewhat and remains in this position when the operating load 4 is at rest.

Due to this twisting, the distance between the bores 28, 29 changes unintentionally, whereby this change does not reflect the operating load 4, but depends on the bending softness of the body 11 in the z-direction. This undesirably changed distance is detected by the deformation sensor and leads to an incorrect measurement of the operating load 4, which may be inadmissible depending on the desired measurement accuracy.

The rectification opening 51 now prevents such a twisting of the edges of the deformation opening 10, in particular of the edge region 13 and the upper edge region 55, in the z-direction, since these regions can no longer be pulled along by the regions 81 of the body 11 lying above the axis 54, but are decoupled from them by the rectification opening 51. In other words, the rectification opening 51 increases the measurement accuracy and prevents erroneous measurement due to the bending softness of the body 11.

FIG. 8 shows a further embodiment of a cantilever arm 60 according to the invention, with a rectification opening 51 according to FIG. 7 and a second rectification opening 61 which is designed analogously to the rectification opening 51. The second rectification opening 61 is also preferably slit-shaped and has an L-shaped structure. In the embodiment shown in the figure, their sections 62, 63 also run over the entire horizontal x or vertical y extent of the deformation opening 10, but with a height section 62 along the anchoring-side edge 12 and with a horizontal section 63 along the lower edge 64 of the deformation opening 10. By means of this second rectification opening 61, the influence of the twisting or bending about the axis 54 is once again reduced and the measurement accuracy is further increased, since the deformation opening 10 is then practically no longer influenced by the twisting in the z-direction, but is still subject to the deformation by the operating load 4 for the detection by a deformation sensor as described above.

This preferably results in a cantilever arm with two rectification openings 51, 61, which are arranged such that they together extend completely around the deformation opening 10, but the adjacent ends of the two rectification openings are spaced from each other by an intermediate region 65, 66 in the body of the cantilever arm.

Furthermore, a cantilever arm 50 is preferably obtained in which the transition region 65 provided on the side of the anchoring side region 2 is simultaneously located on the side of the upper edge region 6 and the transition region 66 provided on the side of the cantilevered side region 8 is simultaneously located on the side of the lower edge region 7. This configuration is particularly favorable with regard to torsion in the z-direction and practically eliminates measurement errors caused by it.

In summary, it can be seen that at least one rectification opening 51, 61 is provided, which runs continuously around the deformation opening 10 at least partially on the side of the anchoring region 2 or the cantilevered side region 8 over the height v and at least partially on the side of the upper edge region 6 or the lower edge region 7 over the horizontal extent h, is preferably slit-shaped, and particularly preferably extends over the entire height v and the entire horizontal extent h of the deformation opening 10. Preferably, at least one of the rectification openings 51, 61 lies entirely within the body 11, particularly preferably both.

It should be noted that, depending on the design of the cantilever arm according to the invention, the position of the axis 54 may change, or that a twisting of the body 11 may take place in a general manner, but in such a way that the body 11 is deflected from its plane in the z-direction. The rectification openings 51, 61 also achieve the desired effect, namely that the undesired twisting of the body 11 does not result in any measurement error when measuring the value of the operating

FIG. 9 shows the deformation of the cantilever arm 50 of FIG. 8 according to a simulation calculation, wherein the effect of the rectification openings 51,61 is brought into effect by the different position of the opposite edges of each rectification opening 51,61.

FIG. 10 shows a cantilever arm 70 in a further embodiment according to the invention, which has at least one, here two, stiffening elements designed as stiffening ribs 71 and 72, which are arranged on the body 11 and reduce twisting in the z-direction (according to the description above for FIGS. 7 to 9). Preferably, strip-shaped stiffening ribs 71, 72 protrude in the z-direction, i.e. horizontally, at right angles from the body 11 (see also FIG. 11), so that the body 11 of the cantilever arm 70 now has an increased moment of inertia about an axis lying in its plane, e.g. the axis 54. Preferably, at least one stiffening element (here a stiffening rib 71, 72) is provided to prevent twisting of the body 11 of the cantilever arm 70, which stiffening element extends from the anchoring side region 2 towards the cantilevered side region 8 and extends along at least one of the upper 6 or the lower edge region 7 over the horizontal extent h of the deformation opening 10. This reduces a twisting in the z-direction under operating load 4 and further improves measurement accuracy.

FIG. 11 shows the cantilever arm 70 provided with stiffening ribs 71, 72 in a view opposite to the x-direction according to the arrow 73 shown in FIG. 10, wherein the arrow 74 again shows the direction of view on the cantilever arm in FIG. 10. In addition, FIG. 11 shows a vibrating wire sensor 35 according to FIG. 4, which is attached to arms 26, 27 and is not shown in the cantilever arm 70 according to FIG. 10. The vibrating wire sensor is attached to arms 26, 27 via screw connections symbolically represented by lines 75, 76 (arms 26, 27 are omitted to reduce the complexity of the figure). Under the operating load 4, a twisting or bending of the body 11 takes place according to the double arrow 77, wherein the relevant neutral axis 78 of the body 11 is then slightly shifted in the z-direction due to the stiffening elements or stiffening ribs 71, 72. Since the sensor 35 is also located somewhat next to the body 11 in the z-direction, the shifted neutral axis 78 is closer to it than would be the case without stiffening ribs 71, 72 (then the neutral axis would be in the body 11 and would be further away from the sensor 35). This is advantageous because the measurement errors caused by the bending or twisting according to the double arrow 77 arise primarily because the corresponding neutral axis does not pass through the sensor 35 and thus the relative displacement of the bores 28,29 and thus the measurement result is falsified. The stiffening elements (here the stiffening ribs 71, 72) thus have the double effect of suppressing harmful distortion in the z-direction and thus measuring errors and, in the case of a remaining residual torsion, of shifting the neutral axis 78 of the body 11 slightly in the z-direction so that a corresponding residual measuring error is reduced. The result is a correspondingly high measurement accuracy.

FIG. 12 shows a cantilever arm 80 in a preferred embodiment for the most accurate measurement of the operating load 4. Visible are a relief opening 46 according to FIG. 6, two rectification openings 51, 61 according to FIG. 8 and a connecting arrangement with arms 26, 27 according to FIG. 7. Again, to relieve the figure, a deformation sensor, such as a vibrating wire sensor 35, is omitted.

It should be noted here that the features described individually above in the figures can be combined or omitted as desired by the person skilled in the art in the specific case, since although a synergy between the features results, for example, from the embodiment according to FIG. 12, these can in principle also be used individually or in another combination.

As mentioned above, cantilever arms according to the invention are further preferably used in pairs next to each other in a frame in order to jointly support a shelf on which goods can be stored and handled. Preferably, a deformation sensor connected to an evaluation unit is provided in each cantilever arm. Then, preferably, there is a frame with at least one pair of identically designed, mutually associated cantilever arms with features in any combination according to the above description, wherein each pair jointly supports a shelf which is designed to accommodate a variable operating load.

1. A cantilever arm, which can be anchored on one side to an object, having a flat body, which comprises a resilient material and is designed to receive a variable load weight and is positioned in operation with a vertically aligned surface, in such a way that in the operating position it has a height (v) limited by an upper and a lower edge region and a horizontal extension (h), which is limited on the one hand by an anchoring side region for anchoring the cantilever arm to the object and on the other hand by a cantilevered side region opposite thereto, wherein the cantilever arm further comprises a force application arrangement designed for supporting the load weight, characterized in that the flat body of the cantilever arm forms a deformation opening and a connecting arrangement for a deformation sensor for measuring the deformation of the cantilever arm under a current load weight wherein the deformation opening is formed by the flat body, penetrates the flat body and is completely enclosed by the same, wherein all its edge regions lie in the plane of the flat body and it has a horizontal extension (h), limited by the anchoring side region and the cantilevered side region, and a vertical extension (v) limited by the upper and lower edge regions, in such a way that it deforms under a respective, current load weight accordingly in a predetermined manner, wherein the force application arrangement is further formed by the body of the cantilever arm, and is arranged at least partially on the cantilevered side region, such that in the operating position of the cantilever arm at least a portion of the load weight is introduced into the cantilevered side region without any relative displacement between the portion of the force application arrangement arranged on the cantilevered side region and the cantilevered side region, and wherein the connecting arrangement is designed to clamp a deformation sensor between the anchoring side region and the cantilevered side region such that said sensor is operational.

2. The cantilever arm according to claim 1, wherein the connecting arrangement has at least one arm which projects into the deformation opening from a side region and has a connecting device for the deformation sensor at a head region.

3. The cantilever arm according to claim 1, wherein the connecting arrangement has two arms, one arm projects from the anchoring side region and the other arm projects from the cantilevered side region into the deformation opening, and each arm has a head region with a connecting device for the deformation sensor.

4. The cantilever arm according to claim 3, wherein the two arms are designed such that their connecting devices for the deformation sensor are arranged substantially vertically one above the other at a distance in the operating position of the cantilever arm.

5. The cantilever arm according to claim 3, wherein the head region of the arm from the anchoring side region is closer to the upper side region and the head region of the arm from the cantilevered side region is closer to the lower edge region of the cantilever arm.

6. The cantilever arm according to claim 1, further comprising a deformation sensor operatively clamped in the connecting arrangement.

7. The cantilever arm according to claim 6, wherein the deformation sensor has an elastically deformable body which is clamped in the connecting arrangement in such a way that it is elastically deformed by a deformation of the deformation opening, and wherein a deformation measuring element is arranged on the elastic body and detects a deformation of the elastic body.

8. The cantilever arm according to claim 7, wherein the deformation measuring element is designed as a vibrating wire and the deformation sensor is designed as a vibrating wire sensor.

9. The cantilever arm according to claim 1, wherein the force application arrangement is designed such that in the operating position of the cantilever arm substantially the entire operating load is introduced into the cantilevered side region.

10. The cantilever arm according to claim 1, wherein the force application arrangement is provided on the upper edge region and extends at least over the cantilevered side region.

11. The cantilever arm according to claim 10, wherein the force application arrangement extends from the cantilevered side region further beyond the deformation opening (10) and preferably beyond this to beyond the anchoring side region (2).

12. The cantilever arm according to claim 1, wherein, starting from the anchoring side region, a preferably slot-shaped relief opening is provided which extends towards the cantilevered side region, extends over the deformation opening and preferably runs over its entire horizontal extent (h).

13. The cantilever arm according to claim 1, wherein at least one rectification opening is provided, which runs continuously in an L-shaped contour at least partially on the side of the anchoring region or of the cantilevered side region across the height (v) and at least partially on the side of the upper edge region or the lower edge region over the horizontal extension (h) around the deformation opening, is preferably slotted, and particularly preferably extends over the entire height (v) and the entire horizontal extension (h) of the deformation opening.

14. The cantilever arm according to claim 13, wherein two rectification openings are arranged such that they together extend completely around the deformation opening, wherein, however, the respective adjacent ends of the two rectification openings are spaced apart from one another by an intermediate region in the body of the cantilever arm.

15. The cantilever arm according to claim 14, wherein the intermediate region provided on the side of the anchoring side region also lies on the side of the upper edge region and the transition region provided on the side of the cantilevered side region also lies on the side of the lower edge region.

16. The cantilever arm according to claim 1, wherein at least one stiffening element, stiffening rib, is provided against twisting of the body of the cantilever arm, which extends from the anchoring side region against the cantilevered side region and extends along at least one of the upper or lower edge region across the horizontal extension (h) of the deformation opening.

17. The cantilever arm according to claim 1, wherein the stiffening element is designed as a stiffening rib.

18. A frame characterized by at least one pair of identically designed, mutually associated cantilever arms according to claim 1, wherein each pair jointly supports a shelf designed to receive a variable operating load.

19. The frame according to claim 16, wherein a deformation sensor connected to an evaluation unit is provided in each cantilever arm.
